(19) United States
(12) Patent Application Publication
(10) Pub. No.: US 2023/0283945 A1
(43) Pub. Date: Sep. 7, 2023

(54) Speaker device and electronic equipment

(71) Applicant: AAC Microtech (Changzhou) Co., Ltd., Changzhou City (CN)

(72) Inventors: Hongjian Hu, Shenzhen (CN); Shuai Li, Shenzhen (CN)

(21) Appl. No.: 17/833,874

(22) Filed: Jun. 6, 2022

(30) Foreign Application Priority Data
Mar. 4, 2022 (CN) 202220477027.X

(51) Int. Cl. H04R 1/28; H04R 1/02; H04R 7/04

(52) U.S. Cl. CPC H04R 1/2826; H04R 1/028; H04R 7/04; H04R 1/023; H04R 2499/11

(57) ABSTRACT

The application provides a speaker device having a housing and sounding unit. The housing includes an upper housing and a lower housing. A containment space for accommodating the sounding unit is arranged between the upper housing and the lower housing. The sounding unit includes a vibration diaphragm separating the containment space into a front vocal cavity and a rear cavity. A sound conduction channel is provided to connect to the front vocal cavity with the outside world. A pressure relieving hole is communicated with the front vocal cavity. The speaker device can transmit the sound from the sounding unit in the containment space to the outside through the sound conduction channel. The pressure relieving hole can improve the pressure relief ability of the front vocal cavity, thereby improving the distortion of the speaker device and improving the sound quality.

### FIELD OF THE PRESENT DISCLOSURE

The present invention relates to the field of acoustic technology, in particular to a speaker device and electronic equipment using such a speaker device.

### DESCRIPTION OF RELATED ART

With the advent of the mobile Internet era, the number of mobile terminals continues to increase, and the sound components used to play sound are also widely used in many mobile terminals such as mobile phones and tablets. Consumers have higher and higher requirements on the sound quality of mobile terminals when purchasing products.

The speaker box in the related art includes a housing body with a containment space, a sounding unit accommodated in the housing body, and a sound conduction channel formed in the containment space. The sounding unit includes a vibration diaphragm for vibrating sound. The vibration diaphragm separates the containment space into the front vocal cavity and the rear cavity, and the sound conduction channel connects the front vocal cavity with the outside world and forms the front cavity together with the front vocal cavity.

However, the pressure relief capability of the sound conduction channel in the related art is insufficient, resulting in distortion of the output sound of the speaker box and poor sound quality, which affects the user's hearing experience.

### SUMMARY OF THE PRESENT INVENTION

The purpose of the present invention is to provide a speaker device to solve the problems of the speaker box output sound distortion and poor sound quality in the prior art.

Accordingly, the present invention provides a speaker device, including: a housing having an upper housing and a lower housing engaged with each other for forming a containment space; a sounding unit accommodated in the containment space, including a vibration diaphragm for generating sound; a front vocal cavity and a rear cavity formed by the vibration diaphragm separating the containment space; a sound conduction channel formed by the housing and communicating the front vocal cavity with an outside; and a pressure relieving hole opened in the housing communicating with the front vocal cavity.

Optionally, an extension direction of the pressure relieving hole intersects with an extension direction of the sound conduction channel.

Optionally, the pressure relieving hole extends along a first direction, the sound conduction channel extends along a second direction, and an included angle formed between the first direction and the second direction is 40°-50°.

Optionally, a cross-sectional shape of the pressure relieving hole is one of circle, ellipse, semicircle, trapezoid, and square.

Optionally, the pressure relieving hole is arranged on the same side of the sound conduction channel.

Optionally, the sound conduction channel and the pressure relieving hole are both disposed in the lower housing.

Optionally, the upper housing and the lower housing include a matching bucket structure.

Optionally, the speaker device further includes a separation assembly, wherein the separation assembly includes a support component and a breathable separator; the support component is connected to a side of the housing where the sound conduction channel is provided; a structural hole matching the sound conduction channel is opened on the support component, and the breathable separator covers the structural hole.

Optionally, the breathable separator is a mesh cloth.

The present invention further provides an electronic equipment including a speaker device as described above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an exploded view of a speaker device provided by an embodiment of the present invention;

FIG. 2 is a cross-sectional view of a lower housing in FIG. 1 taken along line AA;

FIG. 3 is an isometric view of the speaker device provided by the embodiment of the application;

FIG. 4 is a cross-sectional view of the speaker device taken along line BB in FIG. 3;

FIG. 5 illustrates an electronic equipment provided by the embodiment of the present invention.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

The main headphones and loudspeakers in the current market can be called speakers, the principle of the speaker is to use electromagnetic force to drive the connection component connected to the vibration diaphragm 21 to drive the vibration diaphragm 21 to vibrate to produce sound. Specifically, the change of attraction and repulsion between the energized coil and the magnetic element can drive the connection component to drive the vibration diaphragm 21 to vibrate to generate sound.

As for traditional speaker, a sound conduction channel 14 is set on the housing 1 that is connected with the front vocal cavity 131, so that the sound emitted by the sounding unit 2 can be transmitted from the sound conduction channel 14 to the outside world. In the process of vocalization, the front vocal cavity 131 sound conduction channel 14 will generate a certain degree of resonance, it not only affects the Q value (value of quality factor) of the frequency response curve in the front vocal cavity 131 sound conduction channel 14 part of the resonance peak, but also bring some distortion (in the form of a peak on the THD curve corresponding to the high frequency cutoff frequency). THD is the abbreviation of Total Harmonic Distortion.

In order to reduce resonance, avoid distortion, facilitate subsequent audio adjustment, and achieve higher sound quality. The application provides a speaker device 100.

The application provides a speaker device 100, and the speaker device 100 includes: Housing 1 and sounding unit 2, housing 1 includes an upper housing 11 and a lower housing 12 connected to each other. A containment space 13 for accommodating the sounding unit 2 is provided between the upper housing 11 and the lower housing 12. The sounding unit 2 includes a vibration diaphragm 21 for vibrating sound, which partitions the containment space 13 into a front vocal cavity 131 and a rear cavity 132. The housing 1 is provided with a sound conduction channel 14, and the sound conduction channel 14 connects the front vocal cavity 131 with the outside world and forms a front cavity together. A pressure relieving hole 15 is opened on the housing 1, and the pressure relieving hole 15 is connected with the front vocal cavity 131.

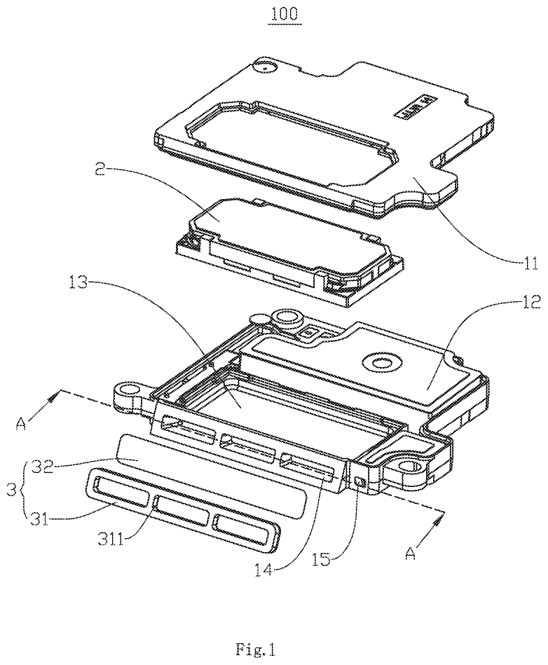

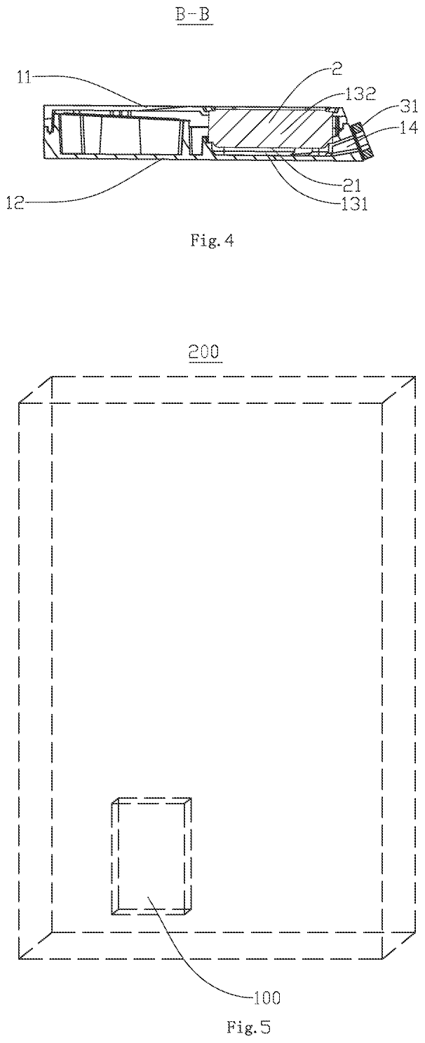

Please refer to FIGS. 1-4, the housing 1 includes an upper housing 11 and a lower housing 12 connected to each other, and the upper housing 11 and the lower housing 12 are arranged oppositely. A conventional snap connection structure can be provided between the upper housing 11 and the lower housing 12, or a corresponding protrusion and groove structure can be provided, and the connection between the upper housing 11 and the lower housing 12 can be realized by using an adhesive.

The main body part of the upper housing 11 can also include four side walls and one top wall. When the upper housing 11 is connected with the lower housing 12, the fixing rib can fix the speaker unit. The main body part of the upper housing 11 can also be a flat plate structure.

The main body part of the lower housing 12 may be provided with a groove capable of accommodating the sounding unit 2. A vibration diaphragm 21 is provided on the sounding unit 2. The vibration diaphragm 21 of the sounding unit 2 is close to the lower housing 12 and is enclosed with the groove to form a space. This space serves as the front vocal cavity 131, and a sound conduction channel 14 is opened on a side wall of the upper housing 11. The front vocal cavity 131 is connected with the sound conduction channel 14 to form a front cavity. The sound produced by the vibration of the vibration diaphragm 21 in the sounding unit 2 is transmitted to the outside of the speaker device 100 via the front vocal cavity 131 and the sound conduction channel 14. The side of the vibration diaphragm 21 of the sounding unit 2 away from the lower housing 12 is connected with the rear vocal cavity.

A pressure relieving hole 15 connecting with the front vocal cavity 131 is opened on the housing 1. Specifically, the pressure relieving hole 15 can be provided in the upper housing 11 or in the lower housing 12. The number and opening positions of the pressure relieving holes 15 can be adjusted according to actual needs and the specific structure of the housing body. As long as it can be ensured that the pressure relieving hole 15 connects the outside world with the front vocal cavity 131.

Since the rear vocal cavity of the speaker device 100 needs to be sealed, that is to say, the position where the upper housing 11 and the lower housing 12 are combined needs to be sealed. The position where the upper housing 11 is combined with the speaker unit also needs to be sealed. In a detailed implementation way, the position where the upper housing 11 is combined with the lower housing 12 and the position where the upper housing 11 is combined with the speaker unit can be sealed by ultrasonic welding, gluing, or crimping.

To sum up, the application sets up a pressure relieving hole 15 on the side surface of the conventional sound conduction channel 14 that connects the front vocal cavity 131 and the outside world. The pressure relief ability of the front vocal cavity 131 is strengthened, and the distortion of the speaker is improved (the THD peak corresponding to the high-frequency cut-off frequency will be attenuated synchronously), so as to facilitate subsequent audio adjustment and achieve higher sound quality.

In the embodiment of any sounding unit 2, the vibration diaphragm 21 can use transparent polymer materials, such as polycarbonate (Polycarbonate, PC), polyethylene terephthalate (Polyethylene Terephthalate, PET), cyclic olefin light polymer (Cyclic Olefin Copolymer, COC), polymethyl methacrylate (Polymethyl Methacrylate, PMMA), etc., which are not limited herein.

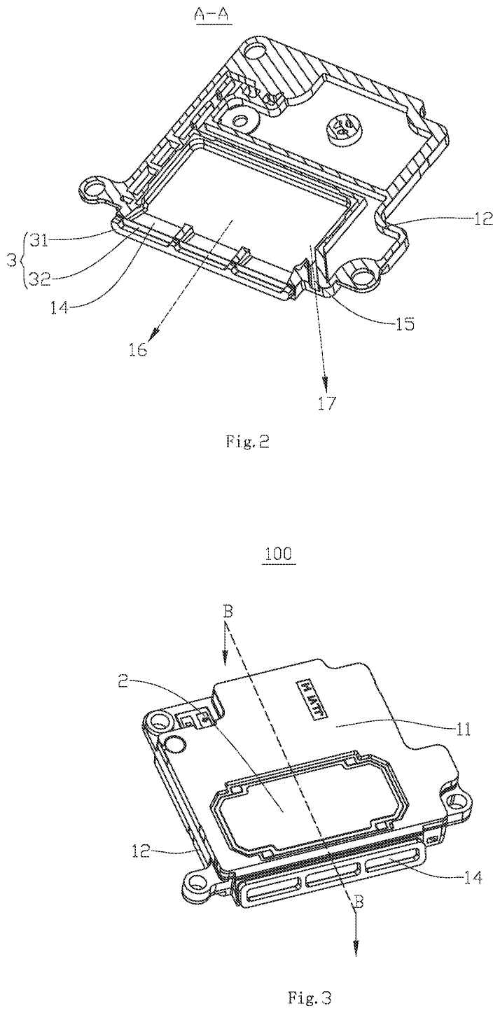

In one of the embodiments, see FIG. 1 and FIG. 2, the extension direction of the pressure relieving hole 15 intersects the extension direction of the sound conduction channel 14.

The extension direction of the pressure relieving hole 15 is the extension direction of the geometric center line of the pressure relieving hole 15, the extension direction of sound conduction channel 14 is the extension direction of the geometric center line of sound conduction channel 14, the extension direction of the pressure relieving hole 15 intersects with the extension direction of the sound conduction channel 14. Because the extension direction of the pressure relieving hole 15 is not parallel to the extension direction of the sound conduction channel 14, the sound waves emitted from the pressure relieving hole 15 and the sound conduction channel 14 can be prevented from interfering with each other to a certain extent, thereby improving the sound quality.

In one of the embodiments, the pressure relieving hole 15 extends along the first direction 16, the sound conduction channel 14 extends along the second direction 17, and the angle between the first direction 16 and the second direction 17 is 40°˜50°.

Please refer to FIG. 2, limit the angle between the extension direction of the pressure relieving hole 15 and the extension direction of the sound conduction channel 14 between 40°˜50° to avoid the mutual interference of the sound waves from the pressure relieving hole 15 and the sound conduction channel 14, to avoid distortion and thus improve sound quality.

In one of the embodiments, the cross-sectional shape of the pressure relieving hole 15 is one of circle, ellipse, semicircle, trapezoid, and square.

Please refer to FIG. 1, the cross-sectional shape of the pressure relieving hole 15 can be a circle, an ellipse, a semicircle, a trapezoid, a square, or a combination of any two or more of the above shapes. By adjusting the cross-sectional shape of the pressure relieving hole 15, the sound texture and sound quality of the speaker device 100 can be finely adjusted, thereby improving the user's listening experience.

In one of the embodiments, the sound conduction channel 14 includes three spaced rectangular channels.

Please refer to FIGS. 1-3, three spaced rectangular channels can be arranged in the horizontal direction on the lower housing 12. In this way, the vertical space of the lower housing 12 can be saved, thereby reducing the thickness of the speaker device 100, so as to realize the miniaturization and light-weight design of the speaker device 100.

In one of the embodiments, the pressure relieving hole 15 is placed on the same side of the sound conduction channel 14. In this way, the sound quality and sound quality of the speaker device 100 can be improved, thereby improving the user's listening experience.

In one of the embodiments, both the sound conduction channel 14 and the pressure relieving hole 15 are set in the lower housing 12.

Please refer to FIG. 2, the sound conduction channel 14 and the pressure relieving hole 15 can be set on the side wall of the lower housing 12, which can ensure the sealing of the sound conduction channel 14 and the pressure relieving hole 15, and also facilitate the processing of the sound conduction channel 14 and the pressure relieving hole 15.

In one of the embodiments, the upper housing 11 and the lower housing 12 are provided with matching bucket structures.

In an optional implementation manner, the upper housing 11 is provided with a bucket slot on the side close to the lower housing 12, the lower housing 12 is provided with a protruding edge on the side close to the upper housing 11, or the upper housing 11 is provided with a protruding edge, and the lower housing 12 is provided with a bucket slot. Therefore, through the cooperation of the protruding edge and the buckle slot, the upper housing 11 can be clamped to the lower housing 12, the structure is simple, the connection is convenient, and the use effect is improved.

In one of the embodiments, the speaker device 100 also includes a separation assembly 3. separation assembly 3 includes a support component 31 and a breathable separator 32. The support component 31 is connected to the side of the housing 1 with the sound conduction channel 14. A structural hole 311 matching the sound conduction channel 14 is opened on the support component 31, and the breathable separator 32 covers the structural hole 311.

Please refer to FIG. 1. In order to avoid foreign impurities from invading the front vocal cavity 131, separation assembly 3 is also set up in this embodiment. The separation assembly 3 includes a breathable separator 32 and a support component 31 for supporting the breathable separator 32. The support component 31 is connected to the housing 1 and a structural hole 311 matching the sound conduction channel 14 is opened on the support component 31. In this way, the sound can be conducted to the outside along the sound conduction channel 14 and the structural hole 311 without hindrance. The shape and size of the structural hole 311 can be the same as the sound conduction channel 14, so as to minimize the influence of the support component 31 on the sound.

The breathable separator 32 can be set at the end of the support component 31 close to the sound conduction channel 14, or at the end of the support component 31 away from the sound conduction channel 14, or at the middle of the support component 31. The breathable separator 32 separates the support component 31 into two parts. The breathable separator 32 may have a porous structure, so that the breathable separator 32 can not only block external impurities from entering the front vocal cavity 131, but also will not affect the sound propagation from the front vocal cavity 131 to the outside world. The breathable separator 32 is attached to one end of the support component 31 close to the sound conduction channel 14. This structure can greatly increase the volume of the front vocal cavity 131 under the same conditions, so as to improve its high-frequency acoustic performance to a greater extent.

In one of the embodiments, the breathable separator 32 is mesh.

Please refer to FIG. 2, the mesh cloth is attached and fixed to the support component 31. After using this structural design, the damping size can be adjusted by adjusting the size of the structural hole 311 of the support component 31 and the mesh number of the mesh cloth. Thereby, the high-frequency acoustic performance adjustment of the speaker device 100 is realized, and the diversification and flexibility of its performance adjustment are increased.

Please refer to FIG. 5, the application also provides an electronic equipment 200, and the electronic equipment 200 is provided with the speaker device 100 of any of the above. The electronic equipment 200 may be a product that needs to play sound, such as a mobile phone, a tablet computer, a notebook computer, a car machine, a point-of-sale electronic equipment 200, a Walkman, a smart bracelet, a smart watch, an augmented reality equipment or a virtual reality equipment.

The speaker device 100 and electronic equipment 200 provided by the application have at least the following advantages:

The speaker device 100 includes a housing 1 and a sounding unit 2, the housing 1 includes an upper housing 11 and a lower housing 12 connected to each other, and a containment space 13 for accommodating the sounding unit 2 is provided between the upper housing 11 and the lower housing 12. The sounding unit 2 includes a vibration diaphragm 21 for vibrating sound. The vibration diaphragm 21 divides the containment space 13 into the front vocal cavity 131 and the rear cavity 132. The sound emitted by the sounding unit 2 in the containment space 13 is transmitted to the outside world through the sound conduction channel 14, in order to reduce the pressure in the front vocal cavity 131 and the sound conduction channel 14, a pressure relieving hole 15 is opened for the housing body. The pressure relieving hole 15 opened on the housing 1 and connected with the front vocal cavity 131 can improve the pressure relief capability of the front vocal cavity 131. By opening the pressure relieving hole 15, the resonance of the front vocal cavity 131 sound conduction channel 14 can be weakened, and the Q value (value of quality factor) of the resonance peak of the frequency response curve in the front vocal cavity 131 sound conduction channel 14 can be effectively reduced. It can also increase the high-frequency cut-off frequency of the frequency response curve to a certain extent, increase the effective bandwidth of the product, and improve the speaker's distortion (distortion is manifested in the high-frequency cut-off frequency corresponding to the peak on the THD curve).

In conclusion, using the speaker device 100 in the application can effectively reduce the peak of the high-frequency cut-off frequency on the THD curve, improve the distortion of the speaker device 100, and improve the sound quality. It is not needed to take out the first weight 41 and the second weight 42 as a whole, which facilitates the replacement of the drive coil 5.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker device, including:
a housing having an upper housing and a lower housing engaged with each other for forming a containment space;
a sounding unit accommodated in the containment space, including a vibration diaphragm for generating sound;
a front vocal cavity and a rear cavity formed by the vibration diaphragm separating the containment space;
a sound conduction channel formed by the housing and communicating the front vocal cavity with an outside; and
a pressure relieving hole opened in the housing communicating with the front vocal cavity.

2. The speaker device as described in claim 1, wherein an extension direction of the pressure relieving hole intersects with an extension direction of the sound conduction channel.

3. The speaker device as described in claim 1, wherein the pressure relieving hole extends along a first direction, the sound conduction channel extends along a second direction, and an included angle formed between the first direction and the second direction is 40°-50°.

4. The speaker device as described in claim 1, wherein a cross-sectional shape of the pressure relieving hole is one of circle, ellipse, semicircle, trapezoid, and square.

5. The speaker device as described in claim 1, wherein the pressure relieving hole is arranged on the same side of the sound conduction channel.

6. The speaker device as described in claim 1, wherein the sound conduction channel and the pressure relieving hole are both disposed in the lower housing.

7. The speaker device as described in claim 1, wherein the upper housing and the lower housing include a matching bucket structure.

8. The speaker device as described in claim 1 further including a separation assembly, wherein the separation assembly includes a support component and a breathable separator; the support component is connected to a side of the housing where the sound conduction channel is provided; a structural hole matching the sound conduction channel is opened on the support component, and the breathable separator covers the structural hole.

9. the speaker device as described in claim 8, wherein the breathable separator is a mesh cloth.

10. An electronic equipment including a speaker device as described in claim 1.
